(19) United States
(12) Patent Application Publication
(10) Pub. No.: US 2017/0131098 A1
(43) Pub. Date: May 11, 2017

(54) SPIRIT LEVEL STRUCTURE

(71) Applicant: WOODSON COMPANY LTD., Yuanlin City (TW)

(72) Inventor: Wen-Fang YU, Yuanlin City (TW)

(73) Assignee: WOODSON COMPANY LTD., Yuanlin City (TW)

(21) Appl. No.: 15/262,212

(22) Filed: Sep. 12, 2016

(30) Foreign Application Priority Data
Nov. 9, 2015 (TW) 104217911

(51) Int. Cl. G01C 9/34

(52) U.S. Cl. CPC G01C 9/34

(57) ABSTRACT

A spirit level has a base ruler having a hollow chamber and a leveling bubble unit. The leveling bubble unit includes a bubble tube, a bubble tube base and a fixing base. The fixing base has a limit slot for the bubble tube base. The position on the base ruler where the leveling bubble unit is configured has an inlaying opening. The fixing base of the leveling bubble unit is hidden inside the hollow chamber in a sinking style, such that, when the fixing base is placed into the hollow chamber, the tip end of the fixing base is held inside the inlaying opening. The two sides of the top of the fixing base are respectively configured with elastic clasps, and the tip end of the elastic clasp has a slant resisting surface to resist against the corner of the inner wall of the inlaying opening.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a spirit level, and more particularly to an innovative spirit level structure in a sinking style with the fixing base of its leveling bubble unit hidden inside the hollow chamber of the base ruler.

2. Description of Related Art Including Information Disclosed Under 37 CFR 1.97 and 37 CFR 1.98.

A spirit level is a kind of measuring instrument widely used to indicate if a building or any other object is horizontal or vertical, or if the slanted sides of an object are on the same horizontal level. Thus, the application of spirit levels is very common.

When operating a spirit level, due to negligent holding or accidental shock, falling and collision of the spirit level is unavoidable. In case of collision, if the point of collision is on the edges of the spirit level, the measuring accuracy of the spirit level will not be significantly affected, but if the point of collision is on the position of the spirit level where the leveling bubble unit is configured, as the frame of the leveling bubble unit in a prior-art spirit level is usually protruding out of the base ruler of the spirit level, it will suffer from direct impact, causing displacement or deformation. In case of displacement or deformation of the leveling bubble unit, it means the spirit level has lost its measuring accuracy and is no longer usable. Hence, the prior-art spirit level has the problem and disadvantage of short product lifecycle.

Thus, to overcome said problems of the prior art, it would be an advancement in the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

The present invention discloses “an improved spirit level structure”, which has the following main characteristics: the fixing base of the leveling bubble unit is hidden inside the hollow chamber of the base ruler in a sinking style, so that, when the fixing base is placed into the hollow chamber, the top end of the fixing base is held inside the inlaying opening; and the top end of the fixing base is configured with an elastic clasp, the tip end of the elastic clasp has a slant resisting surface to resist against the corner of the inner wall of the inlaying opening, so that the fixing base is fixed in two axial directions. Based on the above innovative structural design and technical characteristics, the present invention gains an advantage over the structure of the prior art in that, when the spirit level suffers from a collision, as the leveling bubble unit has no exposed part, it will not be directed impacted to cause displacement or deformation. Hence, the durability of the spirit level is enhanced and its lifecycle will be longer. This is truly a practical inventive step.

### BRIEF DESCRIPTION OF THE SEVERAL VIEWS OF THE DRAWINGS

FIG. 1 is an assembled perspective view of a preferred embodiment of the structure of the present invention.

FIG. 2 is an exploded perspective view of a partial structure of the preferred embodiment of the structure of the present invention.

FIG. 3 is an exploded sectional view of a partial structure of the preferred embodiment of the structure of the present invention.

FIG. 4 is an assembled sectional view of a partial structure of the preferred embodiment of the structure of the present invention.

FIG. 5 is an enlarged view of Portion B in FIG. 4.

FIG. 6 is a cross-sectional view of the base ruler of the present invention.

FIG. 7 is an exploded perspective view of the second leveling bubble unit of the present invention.

FIG. 8 is an assembled sectional view of the second leveling bubble unit of the present invention.

### DETAILED DESCRIPTION OF THE INVENTION

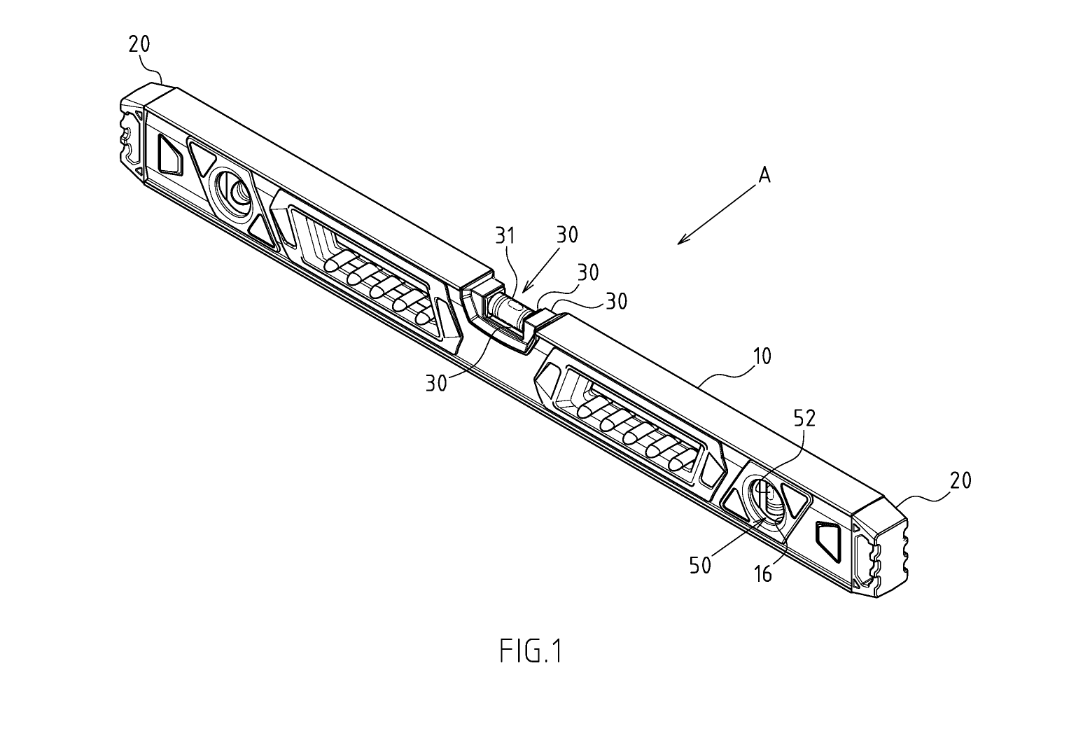

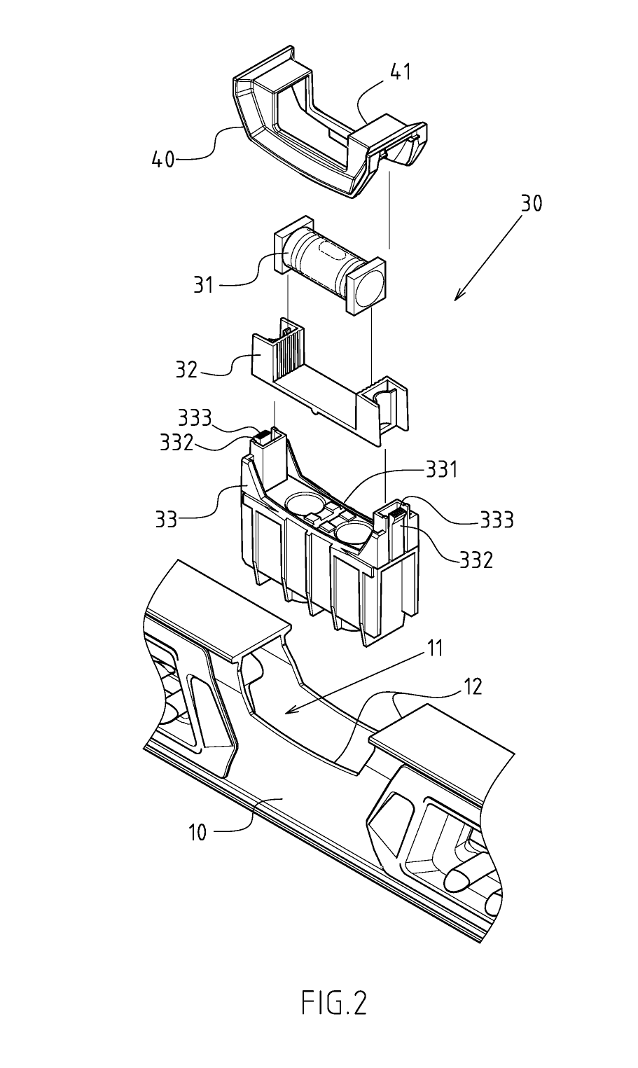

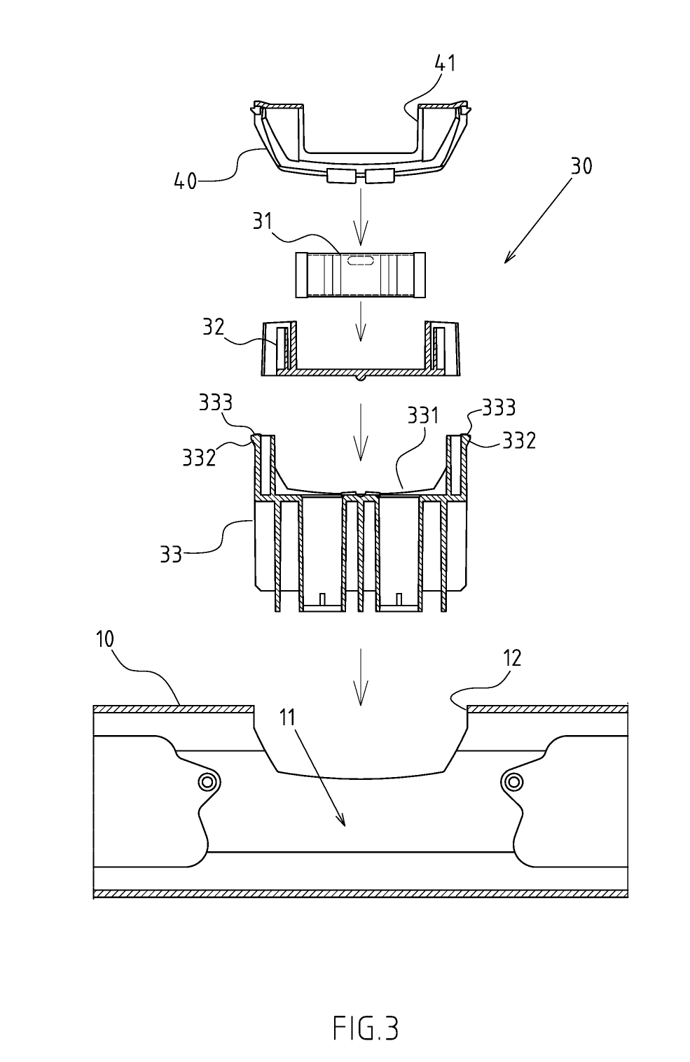

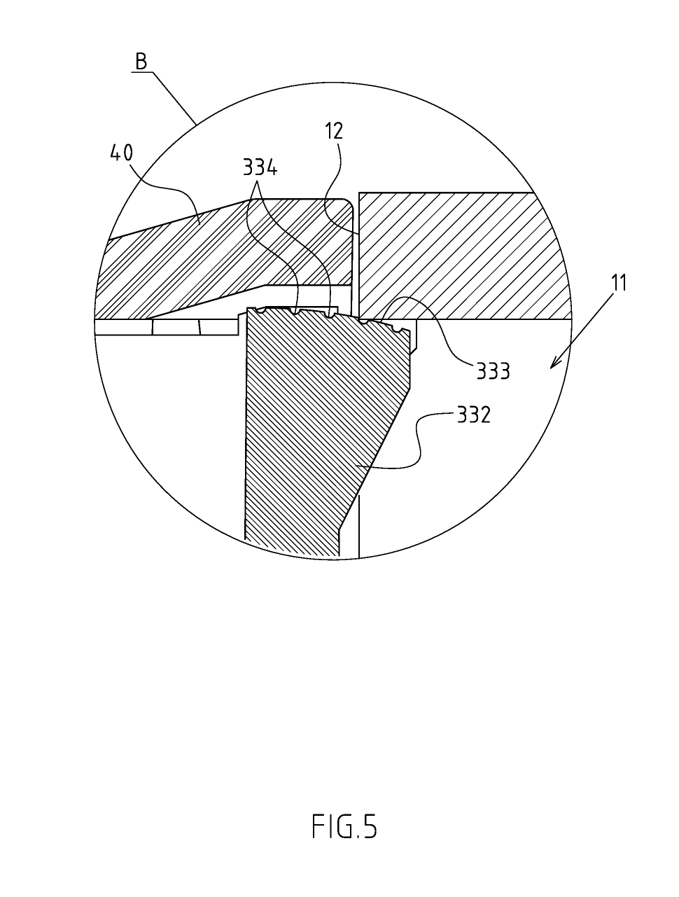

What is disclosed in FIGS. 1 to 5 is a preferred embodiment of the present invention of an improved spirit level structure. However, such an embodiment is for descriptive purposes only, and is not intending to limit the scope of patent claims. Said spirit level A comprises a base ruler 10 having a hollow chamber 11, end caps 20 configured on the two ends of the base ruler 10 and at least one leveling bubble unit 30 configured on the base ruler 10; specifically, the leveling bubble unit 30 includes a bubble tube 31, a bubble tube base 32 and a fixing base 33. The fixing base 33 has a limit slot 331, for the bubble tube base 32 to be inlayed and fixed; The position on the base ruler 10 where the leveling bubble unit 30 is configured has an inlaying opening 12, which is communicated to the hollow chamber 11; specifically, the fixing base 33 of the leveling bubble unit 30 is hidden inside the hollow chamber 11 of the base ruler 10 in a sinking style, such that when the fixing base 33 is placed into the hollow chamber 11, the top of the fixing base 33 is held inside the inlaying opening 12, and specifically, the relative two sides of the top of the fixing base 33 are respectively configured with at least one elastic clasp 332. The tip end of the elastic clasp 332 has a slant resisting surface 333, to resist against the corners of the inner wall of the inlaying opening 12 (as shown in FIG. 5), so that the fixing base 33 is fixed in two axial directions.

Referring to FIGS. 1 to 4, the outside of the inlaying opening 12 can be further provided with an external protecting cap 40. The external protecting cap 40 is to completely cover the inlaying opening 12. The middle of the external protecting cap 40 is configured with a vent 41 for the bubble tube 31 of the leveling bubble unit 30 to expose.

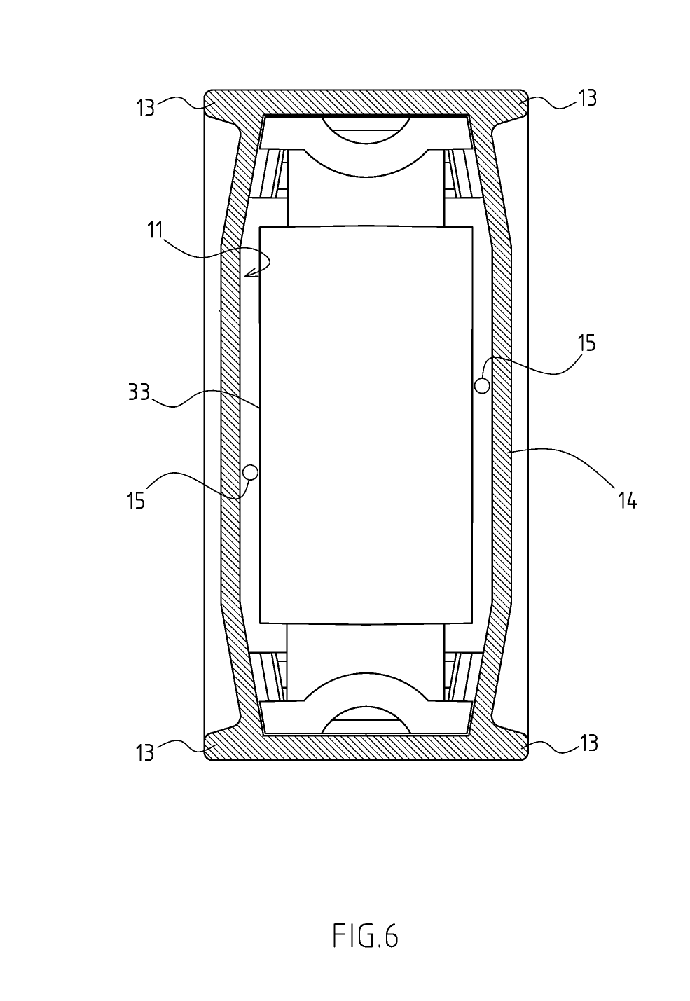

Referring to FIG. 6, the cross section of the base ruler 10 can be roughly in a “II” shape, such that the two edges of its narrower sides are formed with strengthening convex ribs 13 that protrude outward, and the middle section of the wall of the wider sides of the base ruler 10 are further formed with an external bulging portion 14. Between the inner side of the external bulging portion 14 and the fixing base 33 of the leveling bubble unit 30, an anti-collision shrinking gap 15 is formed. The advantage of this embodiment is that, based on the design of the strengthening convex ribs 13, the structural rigidity at each corner of the base ruler 10 is enhanced, so that, when it is subject to collision, it will not deform or be damaged easily. The configuration of the anti-collision shrinking gap 15 is to form a shrinking space between the fixing base 33 of the leveling bubble unit 30 and the wall of the base ruler 10, such that when the wall of the base ruler 10 has a shrinking deformation due to collision, it will minimize the likeliness of displacement of the fixing base 33 suffering from the impact.

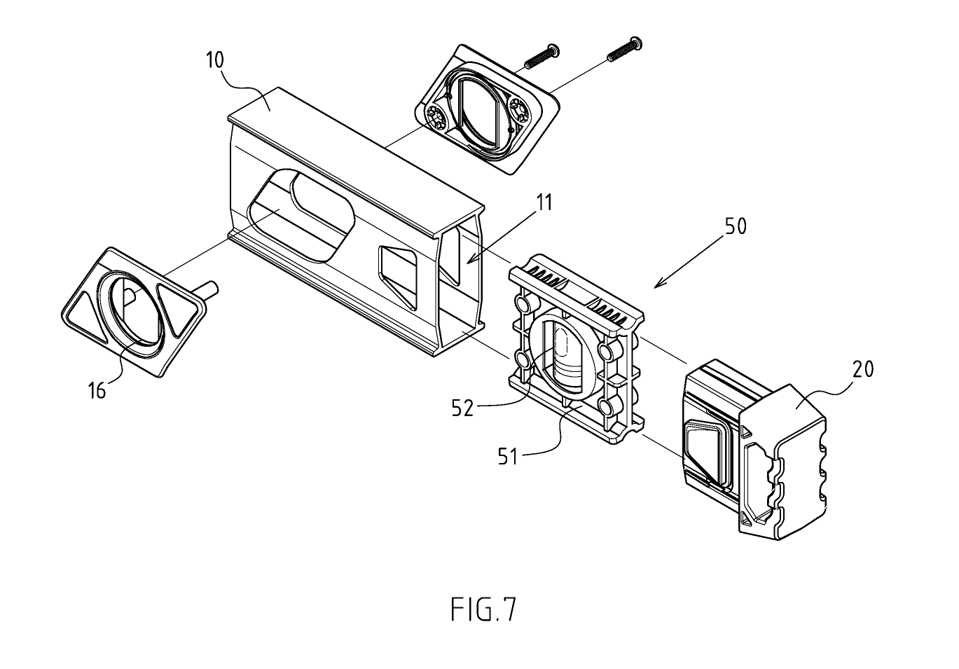

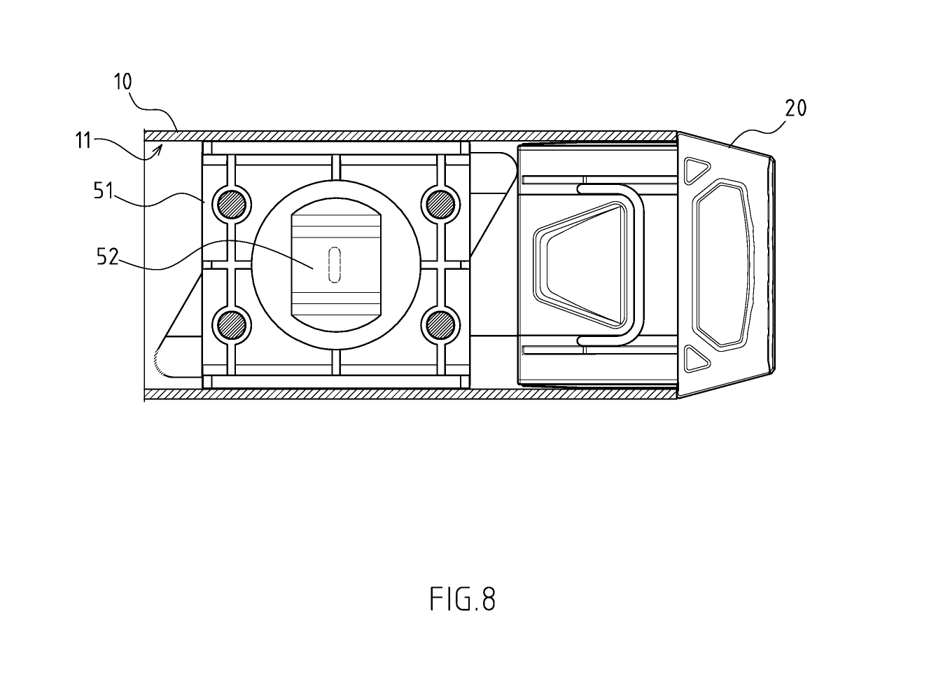

Referring to FIGS. 7 and 8, inside the hollow chamber 11 of the base ruler 10 and at the position close to the end cap 20, a second leveling bubble unit 50 is configured. The second leveling bubble unit 50 includes a second fixing base 51 and a second bubble tube 52 configured on the second fixing base 51. The placement direction of the second bubble tube 52 is perpendicular to the placement direction of the bubble tube 31 of the leveling bubble unit 30. The second fixing base 51 is held inside the hollow chamber 11 of the base ruler 10 in a tightly fitting manner. The two sides of the base ruler 10 are provided with viewing holes 16 for the second bubble tube 52 to expose. The second leveling bubble unit 50 disclosed in this embodiment also adopts a configuration manner that it is held inside the hollow chamber 11 to avoid deformation due to collision. This is the efficacy that the present invention is seeking to achieve.

Referring to FIG. 5, the slant resisting surface 333 on the tip end of the elastic clasp 332 is further formed with teeth edges 334 distributed at intervals. The configuration of the teeth edges 334 in this embodiment is mainly to enhance the friction of the slant resisting surface 333, so that it is fixed more stably.

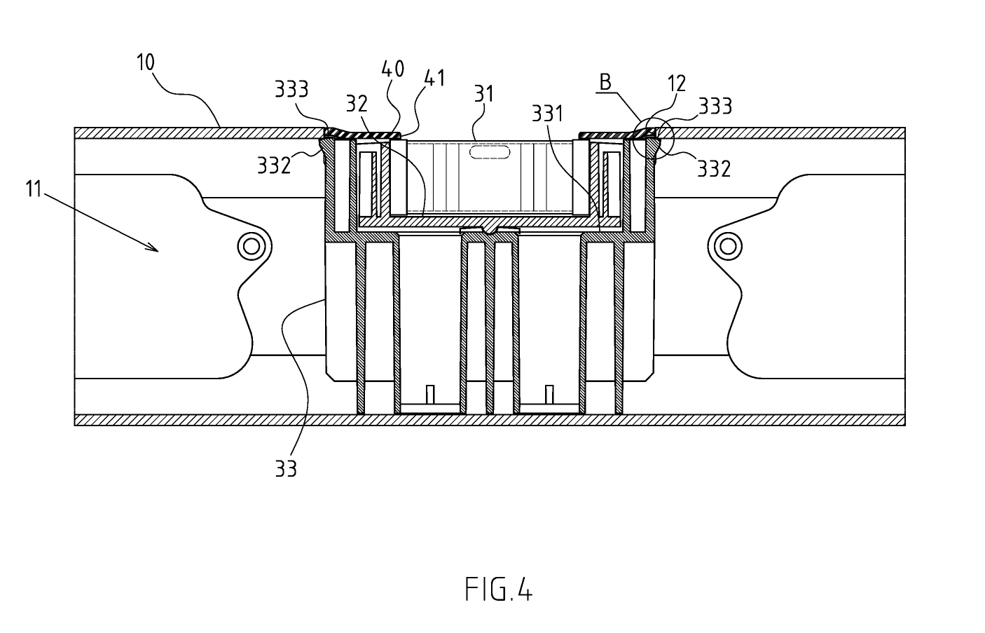

Based on the above structural design, in the case of the preferred embodiment of spirit level A disclosed in the present invention, to mount its leveling bubble unit 30, firstly fit the bubble tube 31 into bubble tube base 32, and then embed the bubble tube base 32 in the limit slot 331 of the fixing base 33. The bubble tube base 32 normally has the function of fine-tuning the horizontality. Usually, glue is applied between the bubble tube base 32 and the limit slot 331, and the adjustment is done before the glue is hardened; on the other hand, the fixing base 33 is placed into the hollow chamber 11 through the inlaying opening 12 configured on the base ruler 10. After the fixing base 33 is placed into the hollow chamber 11, the slant resisting surfaces 333 on the tip end of the elastic clasps 332 respectively configured on the two sides of the top of the fixing base 33 will resist against the corners of the inner walls of the inlaying opening 12 (refer to FIGS. 4 and 5), so that the fixing base 33 is firmly fixed in two axial directions (i.e., the vertical direction and horizontal direction marked in the drawing). Meanwhile, the top end of the fixing base 33 is held inside the inlaying opening 12. Thus, when the base ruler 10 is subject to collision by a foreign object, unless the foreign object directly impacts on the bubble tube 31, it will not directly impact on the leveling bubble unit 30. Hence, the present invention can greatly reduce the likeliness of displacement or deformation of the leveling bubble unit 30 due to collision.

I claim:

1. An improved spirit level structure comprises a base ruler having a hollow chamber, end caps configured on the two ends of the base ruler and at least one leveling bubble unit configured on the base ruler, wherein the leveling bubble unit includes a bubble tube, a bubble tube base and a fixing base; the fixing base has a limit slot, for the bubble tube base to be inlayed and fixed; the position on the base ruler where the leveling bubble unit is configured has an inlaying opening, which is communicated to the hollow chamber; characteristically:
the fixing base of the leveling bubble unit is hidden inside the hollow chamber of the base ruler in a sinking style, such that when the fixing base is placed into the hollow chamber, the top of the fixing base is held inside the inlaying opening, and specifically, the relative two sides of the top of the fixing base are respectively configured with at least one elastic clasp; the tip end of the elastic clasp has a slant resisting surface, to resist against the corner of the inner wall of the inlaying opening, so that the fixing base is fixed in two axial directions.

2. The structure defined in claim 1, wherein the outside of the inlaying opening is further provided with an external protecting cap; the external protecting cap is to completely cover the inlaying opening; the middle of the external protecting cap is configured with a vent for the bubble tube of the leveling bubble unit to expose.

3. The structure defined in claim 2, wherein the cross section of the base ruler is roughly in a “II” shape, such that the two edges of its narrower sides are formed with strengthening convex ribs that protrude outward, and the middle section of the wider sides of the base ruler are further formed with an external bulging portion; between the inner side of the external bulging portion and the fixing base of the leveling bubble unit, an anti-collision shrinking gap is formed.

4. The structure defined in claim 3, wherein, inside the hollow chamber of the base ruler and at the position close to the end cap, a second leveling bubble unit is configured; the second leveling bubble unit includes a second fixing base and a second bubble tube configured on the second fixing base; specifically, the placement direction of the second bubble tube is perpendicular to the placement direction of the bubble tube of the leveling bubble unit; the second fixing base is held inside the hollow chamber of the base ruler in a tightly fitting manner; furthermore, the two sides of the base ruler are provided with viewing holes for the second bubble tube to expose.

5. The structure defined in claim 4, wherein, the slant resisting surface on the tip end of the elastic clasp is further formed with teeth edges distributed at intervals.
